(19) United States
(12) Patent Application Publication
(10) Pub. No.: US 2012/0239507 A1
(43) Pub. Date: Sep. 20, 2012

(54) Sending Notifications to Users Based on Users' Notification Tolerance Levels

(76) Inventor: David Edward Braginsky, San Francisco, CA (US)

(21) Appl. No.: 13/051,286

(22) Filed: Mar. 18, 2011

(51) Int. Cl. G06Q 30/00; G06F 15/173

(52) U.S. Cl. 705/14.69; 709/224

(57) ABSTRACT

In one embodiment, a first computing device accesses a notification to be pushed to a second computing device associated with a user; computes a score for the notification based at least in part on a current level of tolerance of the user to notifications pushed to the second computing device; and if the score is above a predetermined threshold, then pushes the notification to the second computing device.

### TECHNICAL FIELD

This disclosure generally relates to pushing notifications to users and, in some particular embodiments, relates to determining whether to push notifications to users' mobile devices based on the users' notification tolerance levels.

### BACKGROUND

In network communications, there are two ways to send a communication from one device to another device: push and pull. With push technology, the request for the communication transaction is initiated by the sending device. That is, the sending device “pushes” the communication, so to speak, to the receiving device. In this case, the sending device may be considered the active party and the receiving device may be considered the passive party in the transaction. In contrast, with pull technology, the request for the communication transaction is initiated by the receiving device. That is, the receiving device “pulls” the communication, so to speak, from the sending device. In this case, the sending device may be considered the passive party and the receiving device may be considered the active party in the transaction.

### SUMMARY

This disclosure generally relates to pushing notifications to users' mobile devices and more specifically relates to determining whether to push notifications to users' mobile devices based on the users' notification tolerance levels.

In particular embodiments, one or more first computing devices access a notification to be pushed to a second computing device associated with a user; compute a score for the notification based at least in part on a current level of tolerance of the user to notifications pushed to the second computing device; and if the score is above a predetermined threshold, then push the notification to the second computing device.

These and other features, aspects, and advantages of the disclosure are described in more detail below in the detailed description and in conjunction with the following figures.

### BRIEF DESCRIPTION OF THE DRAWINGS

FIG. 1 illustrates an example method for pushing notifications to users' devices based on the users' notification tolerance levels.

FIG. 2 illustrates an example network environment.

FIG. 3 illustrates an example computer system.

### DESCRIPTION OF EXAMPLE EMBODIMENTS

This disclosure is now described in detail with reference to a few embodiments thereof as illustrated in the accompanying drawings. In the following description, numerous specific details are set forth in order to provide a thorough understanding of this disclosure. However, this disclosure may be practiced without some or all of these specific details. In other instances, well known process steps and/or structures have not been described in detail in order not to unnecessarily obscure this disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

In network communications, one device may “push” a communication to another device. In particular embodiments, with push technology, the sending device typically initiates the communication transaction and may transmit the communication to the receiving device without obtaining a permission from the receiving device first. In other words, the communication is “pushed” to the receiving device regardless of whether the receiving device actually wants to receive the communication.

Push technology may be used under various circumstances. For example, in particular embodiments, a server may push communications to a client. More specifically, in particular embodiments, the client may be a mobile client capable of wireless communications (e.g., a mobile telephone, a smart phone, a tablet computer, etc.), and the server may push communications, sent over a mobile network or a wireless network, to the mobile client. Alternatively or in addition, in particular embodiments, the client may be a computing device (e.g., a desktop computer) capable of connecting to a network through a wired connection (e.g., an Ethernet connection). The server may push communications to the client over a computer network (e.g., the Internet).

In particular embodiments, a social-networking system implemented, for example, as a social-networking website, may push communications to the client devices of its users. A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities. For example, the social-networking website operated by Facebook, Inc. at www. facebook.com enables its users to communicate with their friends via emails, instant messages, or blog postings, organize social events, share photos, receive news of their friends or interesting events, play games, etc.

There are various types of communications that may be pushed to a client, such as, for example and without limitation, system update messages, advertisements, alerts, user account notices, social-networking messages, service agreement updates, or a combination of different types of communications. This disclosure contemplates any applicable types of communications. In particular embodiments, a communication pushed to a client may be referred to as a “push notification”. An example push notification is a Short Message Service (SMS) notification. The content of the individual notifications may vary. For example, notifications may be based on a user's social information, such as that found in the user's profile, which may include the user's social connections, stated interests or hobbies, profession, demographical information, and so on. For example, when a user and one of the user's connections are both in a shopping mall at the same time, a notification may be pushed to the user's device, informing the user that a friend of his/hers is nearby. As another example, if a user has expressed an interest in tennis, advertisements on tennis-related products (e.g., tennis shoes, tennis brackets, etc.) may be pushed to the user's device from time to time.

Given the relatively small size of the display of a typical mobile device, such notifications are often displayed as overlays on the current interface view. Some push notifications may be interruptive and some may be non-interruptive. In particular embodiments, an interruptive push notification, when pushed to a client, may be presented to the user of the client immediately or soon after it is received by the client. Even if the user is performing other activities with the client, the activities may be interrupted and suspended by the interruptive push notification. The user may need to respond to the interruptive push notification first before he/she can continue with performing the other activities with the client. For example, suppose that an error alert is pushed to a smart phone (e.g., an iPhone or Blackberry) while the user of the smart phone is checking map directions using Google Maps. If the error alert is an interruptive notification, then the error alert may be presented to the user immediately after it is received by the smart phone, and the user may need to respond to the error alert (e.g., push a button to indicate that the user is aware of the error) before the user may continue with checking map directions.

Sometimes, certain types of interruptive notifications, if pushed to a client device too often, especially within a relatively short period of time, may annoy the user of the client device. For example, if 20 advertisements are pushed to a smart phone within an hour, each requiring the user of the smart phone to respond to it before the user can perform other activities with the smart phone, the user may become very annoyed with the advertisements. In particular embodiments, at any given time, a user may have a certain level of tolerance to the push notifications and especially to the interruptive push notifications pushed to his/her client device. Of course, different users may have different levels of tolerance to the push notifications pushed to their client devices. The same user may have different levels of tolerance to the push notifications pushed to his/her client device at different times. And the same user may have different levels of tolerance to different types of push notifications pushed to his/her client device. Particular embodiments may determine whether to push a notification to a user's client device at a given time depending on the user's notification tolerance level at that time.

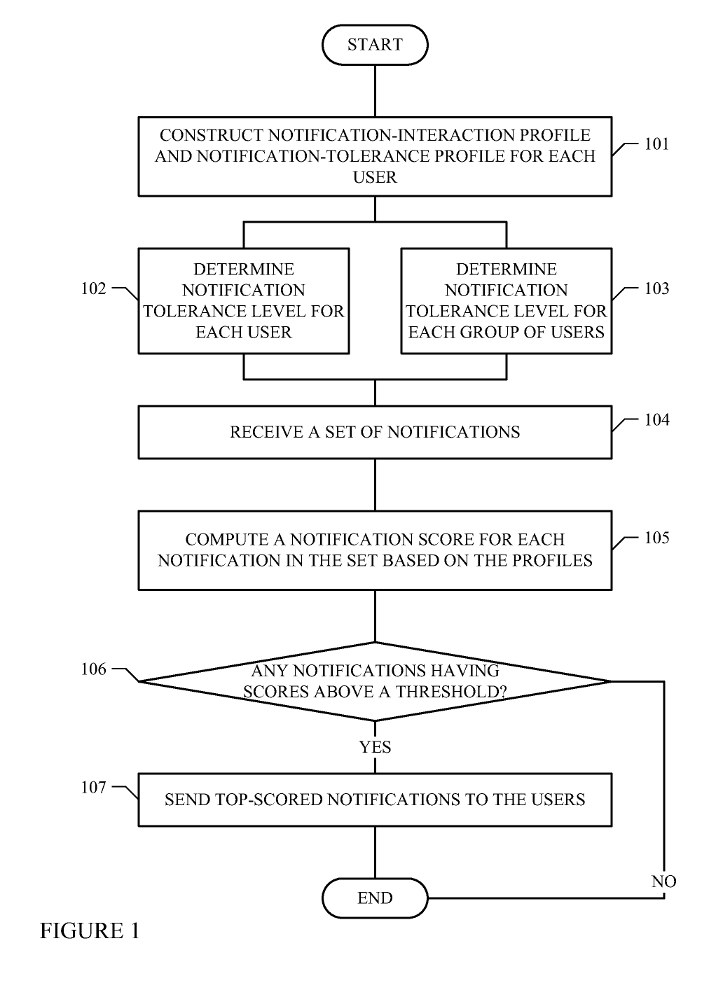

FIG. 1 illustrates an example method for pushing notifications to users' devices (e.g., mobile devices) based on the users' notification tolerance levels. Particular embodiments may construct a notification-interaction profile and a notification-tolerance profile for each user by collecting each user's online activities and/or offline activities, especially activities in connection with the notifications sent to their respective client devices, over some period of time, as illustrated in STEP 101. Any online and/or offline activities of a user may be monitored and collected for the purpose of constructing the notification-interaction and notification-tolerance profiles for a user. When notifications are pushed to the user's client device, particular embodiments may monitor and collect information such as, for example and without limitation, whether the user interacts with the notifications and how much interaction there is between the user and the notifications, how many notifications have been pushed to the user's client device during a specific period of time, the types of notifications that have been pushed to the user's client device during a specific period of time, the parties associated with or sponsoring the notifications, and so on. For example, if the notification is an advertisement, then information such as whether the user actually views the content of the advertisement or just deletes it, the specific time the advertisement is pushed to the user's client device, the location of the client device (e.g., the GPS coordinates of the client device) when the advertisement is received at the user's client device, the type or content of the advertisement, the entity (e.g., advertiser) or device (e.g., advertising server or node) associated with the advertisement, the number of advertisements that have been pushed to the user's client device previously on the same day and their content may be collected. Particular embodiments may track the user's current location at a given time based on the location of the user's mobile device (e.g., derived from the GPS coordinates or the communication signals of the user's mobile device). Particular embodiments may monitor and collect any sensor data supplied by the user's device, such as, for example and without limitation, acceleration, speed, temperature, the user's current activities with the device (e.g., making a phone call, sending or receiving an email, taking a photo, or surfing the web), and so on. Particular embodiments may monitor and collect the user's calendar information to determine, for example, when the user has a scheduled appointment and where, during which periods the user is at work and at home respectively, and so on. Particular embodiments may monitor and collect information concerning the user's social activities, either through a social-networking website or other channels, whether the user has subscribed to receive information about certain types of products, whether the user has bought any products that are described in the notifications pushed to the user's device, and so on. Again, any available information concerning the user or the user's activities may be monitored and collected and used to construct the notification-interaction profile and the notification-tolerance profile for the user.

From such information, particular embodiments may construct the notification-interaction and notification-tolerance profiles for the user, as illustrated in STEP 102. In particular embodiments, the notification-interaction profile of a user may indicate the user's characteristics such as how often the user interacts with the notifications, the types or content of the notifications with which the user is more likely to interact and the types or content of the notifications with which the user is less likely to interact, the time of day the user is more likely to interact with the notifications and the time of day the user is less likely to interact with the notifications, the locations where the user is more likely to interact with the notifications and the types of the notifications connected with the locations, and so on. In particular embodiments, the notification-tolerance profile of a user may indicate the user's characteristics such as at a given time or at a specific location, the level of tolerance the user has to the notifications, the types or contents of the notifications that the user may have a higher level of tolerance and the types or contents of the notifications that the user may have a lower level of tolerance either generally or at a specific time or location, and so on.

In particular embodiments, each user's online activities may be continually monitored and collected so that each user's notification-interaction and notification-tolerance profiles may be updated from time to time based on the newly collected information. For example, a user may develop a new interest in a product. Previously, the user may ignore and delete the advertisements pushed to the user's client device about the product. But after the user has developed an interest in the product, the user may interact and view the advertisements pushed to the user's client device about the product. The user's profiles may be updated to reflect this change in the user's interest as the user's interactions with the advertisements are collected.

Particular embodiments may categorize the user into one or more user groups based on, for example, common user characteristics, such as age, gender, geographical location, profession, and so on. In addition to constructing the notification-interaction and notification-tolerance profiles for each user, particular embodiments may construct a notification-interaction profile and a notification-tolerance profile for each user group as well. Particular embodiments may aggregate the information collected for the individual users in a user group and construct the notification-interaction and notification-tolerance profiles for the user group based on the aggregated user information, as illustrated in STEP 103.

Suppose that there is a set of notifications that needs to be pushed to the client devices of the users, as illustrated in STEP 104. For each notification in the set, there may be one or more parties involved. Different types of notifications may be associated with different parties. For example, if the notification is an advertisement, the parties associated with the advertisement may include the user, the system actually pushing the advertisement to the user's client device, and the advertiser of the advertisement. If the notification is a system update notice, the parties associated with the system update notice may include the user and the system actually pushing the system update notice.

Pushing a notification to a user's client device may result in some benefit and some cost to each party associated with the notification. The costs and benefits can vary depending on the type of notification and its commercial or non-commercial nature. For example, if the notification is an advertisement, the user receiving the advertisement may receive some useful information about a product that the user is potentially interest in (benefit), but the user's activity may be interrupted by the notification and the user may be annoyed if the user is not interested in the product (cost). The system sending the notification may receive a payment from the advertiser for sending the notification (benefit), but the transmission requires a certain amount of bandwidth and the user may be annoyed at the system (cost). The payments received by the system may be based on a cost-per-impression model, a cost-per-click model and/or a cost-per-conversion model. The advertiser may have a potential customer (benefit), but the advertiser needs to pay to have the advertisement sent (cost).

Particular embodiments may compute a score for each notification as the sum of the benefits and the costs to all the parties associated with the notification, as illustrated in STEP 105. In particular embodiments, the score for each notification may be computed as

$$score = {\sum }_{i = 1}^{i \leq P} {α}_{i} {B}_{i} + {\sum }_{i = 1}^{i \leq P} {β}_{i} {C}_{i} ;$$

where: (1) P denotes the total number of parties associated with the notification, (2) Bᵢ denotes the benefit to party i, (3) Cᵢ denotes the cost to party i, and (4) αᵢ and βᵢ denote two coefficients, which may be used to indicate how important a specific benefit or cost is, respectively. In particular embodiments, each benefit, Bᵢ, may be represented as a positive number or zero (if no benefit), and each cost, Cᵢ, may be represented as a negative number or zero (if no cost).

In particular embodiments, a user may be one of the parties associated with each notification, since the notification is pushed to the user's client device. In particular embodiments, the user's level of tolerance to the notifications at the time the notification is to be pushed to the user's client device may be taken into consideration as a part of the cost to the user for pushing the notification to the user's client device. The score of the notification is thus computed based, at least in part, on the user's current level of tolerance to the notifications at the time the notification is to be pushed to the user's client device. In particular embodiments, if the user currently has a relatively low level of tolerance to the notifications, then the cost of pushing the notification to the user's client device may be relatively high. Conversely, if the user currently has a relatively high level of tolerance to the notifications, then the cost of pushing the notification to the user's client device may be relatively low.

In particular embodiments, the likelihood that the user may interact with the notification at the time the notification is to be pushed to the user's client device may be taken into consideration as a part of the benefit and/or as a part of the cost to the user for pushing the notification to the user's client device. The score of the notification is thus computed based, at least in part, on the current likelihood that the user may interact with the notification at the time the notification is to be pushed to the user's client device. In particular embodiments, if the current likelihood that the user may interact with the notification is relatively high, then the benefit of pushing the notification to the user's client device may be relatively high, and/or the cost of pushing the notification to the user's client device may be relatively low. Conversely, if the current likelihood that the user may interact with the notification is relatively low, then the benefit of pushing the notification to the user's client device may be relatively low, and/or the cost of pushing the notification to the user's client device may be relatively high.

In particular embodiments, at a given time, the likelihood that the user may interact with a notification pushed to the user's client device may depend on the user's tolerance level to the notifications. For example, if the user has a higher level of tolerance to the notifications, it may be more likely that the user may interact with a notification pushed to the user's client device. The user may have the patience to view the content of the notification more carefully. Conversely, if the user has a lower level of tolerance to the notifications, it may be less likely that the user may interact with a notification pushed to the user's client device. In fact, the user may ignore and delete the notification while feeling annoyed by it.

As described above, the user's level of tolerance to the notifications at the time the notification is to be pushed to the user's client device may depend on various factors, such as, for example and without limitation, the user's tolerance to the notifications in general (e.g., whether this specific user has a low level or a high level of tolerance to all types of notifications in general), the number of notifications that have already been pushed to the user's client device on the same day, the type or content of the notification to be pushed to the user's client device, the time of day (e.g., morning, afternoon, evening) that the notification is to be pushed to the user's client device, the day of the week (e.g., weekdays or weekends), the location of the user's client device (e.g., at the user's work or home, or at a restaurant or some other place where the user may be spending time with family or friends), whether the user is currently performing some activities with the user's client device, and so on. Particular embodiments may determine the user's level of tolerance to the notifications at the time the notification is to be pushed to the user's client device based, at least in part, on the notification-interaction and notification-tolerance profiles constructed for the user.

Particular embodiments may examine the scores computed for the notifications and determine whether any notifications have scores above a predetermined threshold, as illustrated in STEP 106. The threshold may be determined based on the requirements of the system or any applicable factors. If there is no notification that has a score above the predetermined threshold (STEP 106—“NO”), then particular embodiments do not push any notification to the users' client devices. However, if there are some notifications that have scores above the predetermined threshold (STEP 106—“YES”), then particular embodiments may push one or more top-scored notifications to the users' client devices, as illustrated in STEP 107.

As described above, there are many types of notifications that may be pushed to users' client devices, one of which is advertisements. Other notification types are non-commercial in nature. For example, some notifications can inform a user that one or more contacts of the user are nearby to the user. With online advertising, in particular embodiments, there may be the following parties involved in the advertising process: (1) publishers who actually publish the advertisements in various types of online media; (2) advertisers who need their advertisements published; and (3) users who receive the advertisements. In the above “push notification” scenario, the publisher may be the system pushing the advertisements to the users' client devices. Usually, an advertiser may pay a publisher to have its advertisements published. There may be many types of payment methods between advertisers and publishers. For example, an advertiser may pay a publisher on the cost per mille (CPM), cost per click (CPC), cost per lead (CPL), or other basis.

When there are advertisements to be pushed to the users' client devices, particular embodiments may charge the advertisers based, at least in part, on each user's current tolerance level to the advertisements. For example, particular embodiments may charge an advertiser more for sending an advertisement to a user who currently has a relatively low level of tolerance to advertisements than for sending the advertisement to a user who currently has a relatively high level of tolerance to advertisements. Particular embodiments may refrain from sending advertisements, especially those advertisements with low scores, to users who currently have low levels of tolerance to advertisements or to notifications in general. In addition or alternatively, particular embodiments may charge an advertiser more for sending an advertisement to a user who is likely to interact with the advertisement than for sending the advertisement to a user who is likely to ignore and delete the advertisement. In particular embodiments, a user's level of tolerance to advertisements at a given time may be determined based on the user's notification-tolerance profile and/or based on the notification-tolerance profile of the user group to which the user belongs. In particular embodiments, the likelihood that a user may interact with an advertisement at a given time may be determined based on the user's notification-interaction profile and/or based on the notification-interaction profile of the user group to which the user belongs.

In particular embodiments, the amount to charge an advertiser for pushing an advertisement to a user (i.e., for pushing the advertisement to the user's client device) may be determined in real time (e.g., at the time the advertisement needs to be pushed to the user's client device). In particular embodiments, a model may be constructed, which incorporates various factors relevant to determining the amount to charge each advertiser for pushing each advertisement to each user's client device. In particular embodiments, the notification-interaction and notification-tolerance profiles for the individual users and for each of the user groups may be incorporated in the model so that when determining the amount to charge a specific advertiser for pushing a specific advertisement to a specific user's client device, these notification-interaction and notification-tolerance profiles are taken into consideration.

The method illustrated in FIG. 1 may be used to determine when to push or not to push a notification to a user's device, and if a notification is to be pushed to the user's device, which specific notification should be pushed to the user's device. The content of the notification may concern an entity, which may either be a person (e.g., the user's friend), an organization, or an object (e.g., a product, a web page, a software application). The notifications may originate from the social-networking system (e.g., messages concerning social information) or from a third party (e.g., advertisements about the third party's product).

In particular embodiments, the decisions with respect to a specific user may be made based on the profiles constructed for that user. There may be many factors affecting the decisions regarding whether to push a notification and which notification to push, and this disclosure contemplates any applicable factor. For example, as described above, the decisions may be based on the current time of the day (e.g., morning, afternoon, evening), the day of the week (e.g., weekdays, weekends), the current location of the user, the current activity of the user (e.g., the user is in a meeting or making a phone call, in which cases it may not be advisable to push notifications to the user's device), and so on. The notifications may be determined based on a user's statement on the social-networking system. If a user mentions an entity on the social-networking system, notifications concerning that entity may be pushed to the user's device. For example, if a user mentions a product in a post on the social-networking system, advertisements about that product may be pushed to the user's device. If a user mentions a person (e.g., a friend), the current status of that person may be pushed to the user's device. If a user indicates that he/she likes something (e.g., a product, a movie, a celebrity), then notifications about what the user likes may be pushed to the user's device. If a user likes a web page, then notifications about the entity with which the content of the web page is concerned may be pushed to the user's device.

In particular embodiments, for a given user and a given notification, a relevance score may be computed for the notification with respect to the user, which indicates how relevant the notification is to the user. If the notification is considered relevant to the user (e.g., having a high relevance score), then the notification may be pushed to the user's device. Conversely, if the notification is considered not relevant to the user (e.g., having a low relevance score), then the notification is not pushed to the user's device. In particular embodiments, the relevance score of a notification with respect to a user may be determined based on a location value, which compares the location of the entity of the notification and the current location of the user, an interest value, which indicates whether the entity of the notification is or is not included in the user's interests, a time value, which determines whether the current time is within the delivery time range for the entity of the notification, and a connection value, which indicates the number of the user's social connections are associated with the entity of the notification. These different values may be combined to determine the relevance score. Computing notification relevance score is described in more detail in U.S. patent application Ser. No. 12/976,775, entitled “Pricing Relevant Notifications Provided to a User Based on Location and Social Information”, filed on Dec. 22, 2010, which is incorporated by reference in its entirety and for all purposes.

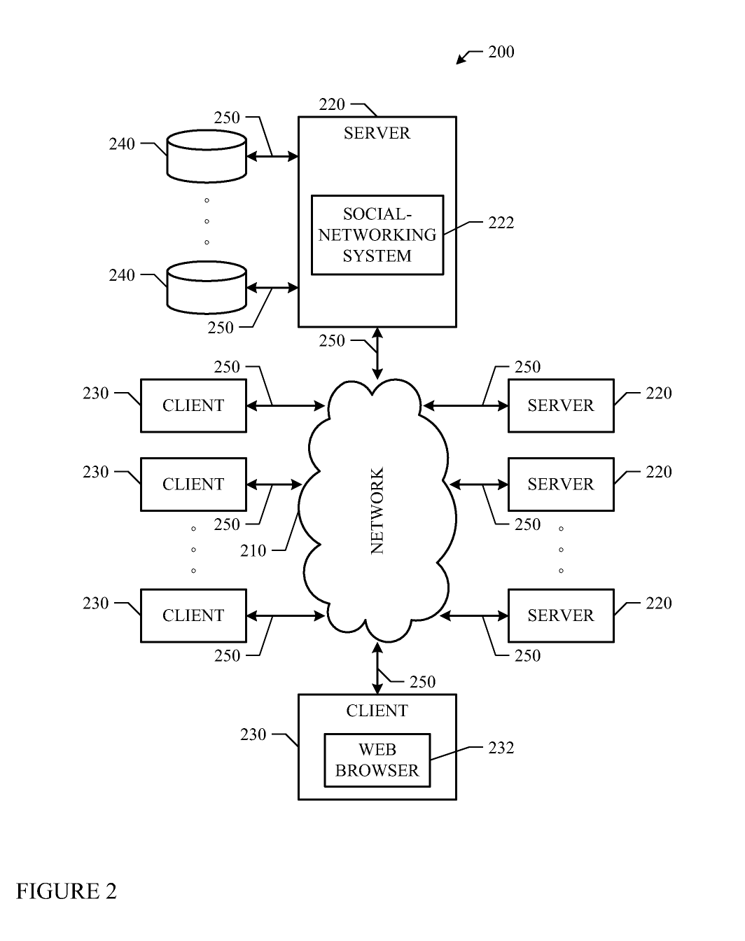

Particular embodiments may be implemented in a network environment. FIG. 2 illustrates an example network environment 200. Network environment 200 includes a network 210 coupling one or more servers 220 and one or more clients 230 to each other. In particular embodiments, network 210 is an intranet, an extranet, a virtual private network (VPN), a local area network (LAN), a wireless LAN (WLAN), a wide area network (WAN), a metropolitan area network (MAN), a portion of the Internet, or another network 210 or a combination of two or more such networks 210. This disclosure contemplates any suitable network 210.

One or more links 250 couple a server 220 or a client 230 to network 210. In particular embodiments, one or more links 250 each includes one or more wireline, wireless, or optical links 250. In particular embodiments, one or more links 250 each includes an intranet, an extranet, a VPN, a LAN, a WLAN, a WAN, a MAN, a portion of the Internet, or another link 250 or a combination of two or more such links 250. This disclosure contemplates any suitable links 250 coupling servers 220 and clients 230 to network 210.

In particular embodiments, each server 220 may be a unitary server or may be a distributed server spanning multiple computers or multiple datacenters. Servers 220 may be of various types, such as, for example and without limitation, web server, news server, mail server, message server, advertising server, file server, application server, exchange server, database server, or proxy server. In particular embodiments, each server 220 may include hardware, software, or embedded logic components or a combination of two or more such components for carrying out the appropriate functionalities implemented or supported by server 220. For example, a web server is generally capable of hosting websites containing web pages or particular elements of web pages. More specifically, a web server may host HTML files or other file types, or may dynamically create or constitute files upon a request, and communicate them to clients 230 in response to HTTP or other requests from clients 230. A mail server is generally capable of providing electronic mail services to various clients 230. A database server is generally capable of providing an interface for managing data stored in one or more data stores. In particular embodiments, a social-networking system 222, implementing a social-networking website, may be hosted on one or more servers 220.

In particular embodiments, one or more data storages 240 may be communicatively linked to one or more severs 220 via one or more links 250. In particular embodiments, data storages 240 may be used to store various types of information. In particular embodiments, the information stored in data storages 240 may be organized according to specific data structures. In particular embodiments, each data storage 240 may be a relational database. Particular embodiments may provide interfaces that enable servers 220 or clients 230 to manage, e.g., retrieve, modify, add, or delete, the information stored in data storage 240.

In particular embodiments, each client 230 may be an electronic device including hardware, software, or embedded logic components or a combination of two or more such components and capable of carrying out the appropriate functionalities implemented or supported by client 230. For example and without limitation, a client 230 may be a desktop computer system, a notebook computer system, a netbook computer system, a handheld electronic device, or a mobile telephone. This disclosure contemplates any suitable clients 230. A client 230 may enable a network user at client 230 to access network 230. A client 230 may enable its user to communicate with other users at other clients 230.

A client 230 may have a web browser 232, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 230 may enter a Uniform Resource Locator (URL) or other address directing the web browser 232 to a server 220, and the web browser 232 may generate a Hyper Text Transfer Protocol (HTTP) request and communicate the HTTP request to server 220. Server 220 may accept the HTTP request and communicate to client 230 one or more Hyper Text Markup Language (HTML) files responsive to the HTTP request. Client 230 may render a web page based on the HTML files from server 220 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

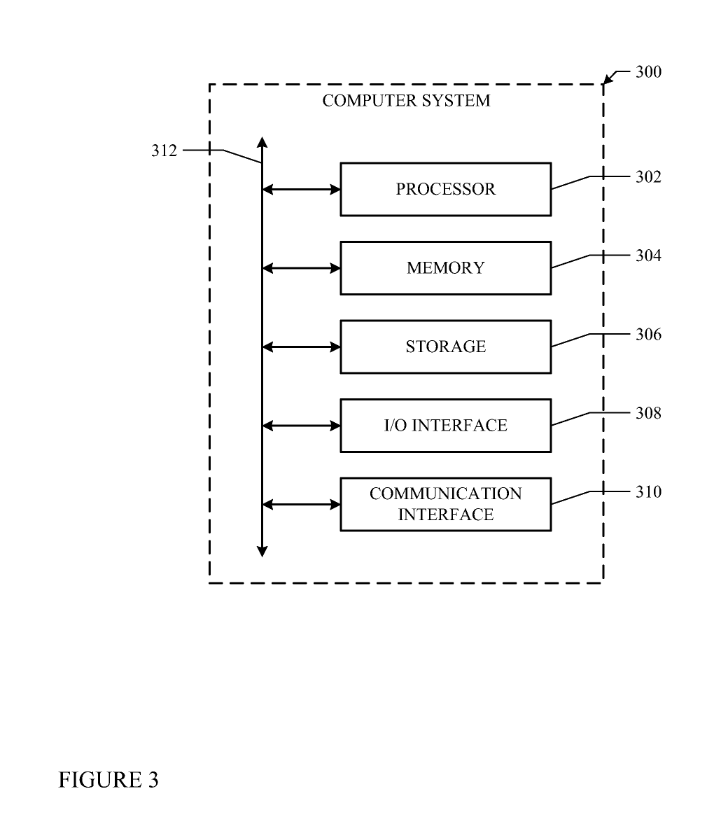

Particular embodiments may be implemented on one or more computer systems. FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 300 may include one or more computer systems 300; be unitary or distributed; span multiple locations; span multiple machines; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include an HDD, a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 302 (such as, for example, one or more internal registers or caches), one or more portions of memory 304, one or more portions of storage 306, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by one or more first computing devices,
accessing a notification to be pushed to a second computing device associated with a user;
computing a score for the notification based at least in part on a current level of tolerance of the user to notifications pushed to the second computing device; and
if the score is above a predetermined threshold, then pushing the notification to the second computing device.

2. The method of claim 1, wherein the score for the notification is further based on a current likelihood that the user interacts with the notifications pushed to the second computing device.

3. The method of claim 1, wherein the notification is one of a plurality of notifications, and the method further comprising:
for each of the plurality of notifications, computing a score for the notification based at least in part on the current level of tolerance of the user to notifications pushed to the second computing device;
if the score of at least one of the plurality of notifications is above the predetermine threshold, then pushing one or more top-scored notifications whose scores are above the predetermine threshold to the second computing device.

4. The method of claim 1, further comprising:
monitoring and collecting one or more activities performed by the user in connection with one or more notifications pushed to the second computing device;
constructing a notification-interaction profile for the user based on the one or more activities; and
constructing a notification-tolerance profile for the user based on the one or more activities.

5. The method of claim 1, further comprising:
for each of a plurality of users associated with a plurality of second computing devices respectively,
monitoring and collecting one or more activities performed by the user in connection with one or more notifications pushed to the second computing device;
constructing a notification-interaction profile for the user based on the one or more activities performed by the user; and
constructing a notification-tolerance profile for the user based on the one or more activities performed by the user;
categorizing the plurality of users into one or more user groups; and
for each of the one or more user groups,
aggregating the one or more activates performed by each user in the user group;
constructing a notification-interaction profile for the user group based on the aggregated activities; and
constructing a notification-tolerance profile for the user based on based on the aggregated activities.

6. The method of claim 1, wherein the notification is an advertisement associated with an advertiser, and the method further comprising:
determining a charge to the advertiser for pushing the advertisement to the second computing device based at least in part on the current level of tolerance of the user to the notifications pushed to the second computing device.

7. The method of claim 6, wherein charge to the advertiser for pushing the advertisement to the second computing device is further based on the current likelihood that the user interacts with the notifications pushed to the second computing device.

8. The method of claim 6, further comprising constructing a model comprising one or more notification-interaction profiles and one or more notification-tolerance profiles for one or more users respectively,
wherein the charge to the advertiser for pushing the advertisement to the second computing device is determined by the model in real time.

9. A first system comprising:
a memory comprising instructions executable by one or more processors; and
the one or more processors coupled to the memory and operable to execute the instructions, the one or more processors being operable when executing the instructions to:
access a notification to be pushed to a second system associated with a user;
compute a score for the notification based at least in part on a current level of tolerance of the user to notifications pushed to the second system; and
if the score is above a predetermined threshold, then push the notification to the second system.

10. The first system of claim 9, wherein the score for the notification is further based on a current likelihood that the user interacts with the notifications pushed to the second system.

11. The first system of claim 9, wherein the notification is one of a plurality of notifications, and the one or more processors are further operable when executing the instructions to:
for each of the plurality of notifications, compute a score for the notification based at least in part on the current level of tolerance of the user to notifications pushed to the second system;
if the score of at least one of the plurality of notifications is above the predetermine threshold, then push one or more top-scored notifications whose scores are above the predetermine threshold to the second system.

12. The first system of claim 9, wherein the one or more processors are further operable when executing the instructions to:
monitor and collect one or more activities performed by the user in connection with one or more notifications pushed to the second system;
construct a notification-interaction profile for the user based on the one or more activities; and
construct a notification-tolerance profile for the user based on the one or more activities.

13. The first system of claim 9, wherein the one or more processors are further operable when executing the instructions to:
for each of a plurality of users associated with a plurality of second systems respectively,
monitor and collect one or more activities performed by the user in connection with one or more notifications pushed to the second system;
construct a notification-interaction profile for the user based on the one or more activities performed by the user; and
construct a notification-tolerance profile for the user based on the one or more activities performed by the user;
categorize the plurality of users into one or more user groups; and
for each of the one or more user groups,
aggregate the one or more activates performed by each user in the user group;
construct a notification-interaction profile for the user group based on the aggregated activities; and
construct a notification-tolerance profile for the user based on based on the aggregated activities.

14. The first system of claim 9, wherein the notification is an advertisement associated with an advertiser, and the one or more processors are further operable when executing the instructions to:
determine a charge to the advertiser for pushing the advertisement to the second system based at least in part on the current level of tolerance of the user to the notifications pushed to the second system.

15. The first system of claim 14, wherein charge to the advertiser for pushing the advertisement to the second system is further based on the current likelihood that the user interacts with the notifications pushed to the second system.

16. The first system of claim 14, wherein the one or more processors are further operable when executing the instructions to construct a model comprising one or more notification-interaction profiles and one or more notification-tolerance profiles for one or more users respectively,
wherein the charge to the advertiser for pushing the advertisement to the second system is determined by the model in real time.

17. One or more computer-readable non-transitory storage media embodying software operable when executed by one or more first computer systems to:
access a notification to be pushed to a second computer system associated with a user;
compute a score for the notification based at least in part on a current level of tolerance of the user to notifications pushed to the second computer system; and
if the score is above a predetermined threshold, then push the notification to the second computer system.

18. The media of claim 17, wherein the notification is one of a plurality of notifications, and the software is further operable when executed by the one or more first computer systems to:
for each of the plurality of notifications, compute a score for the notification based at least in part on the current level of tolerance of the user to notifications pushed to the second computer system;
if the score of at least one of the plurality of notifications is above the predetermine threshold, then push one or more top-scored notifications whose scores are above the predetermine threshold to the second computer system.

19. The media of claim 17, wherein the software is further operable when executed by the one or more first computer systems to:
monitor and collect one or more activities performed by the user in connection with one or more notifications pushed to the second computer system;
construct a notification-interaction profile for the user based on the one or more activities; and
construct a notification-tolerance profile for the user based on the one or more activities.

20. The media of claim 17, wherein the notification is an advertisement associated with an advertiser, and the software is further operable when executed by the one or more first computer systems to:
determine a charge to the advertiser for pushing the advertisement to the second computer system based at least in part on the current level of tolerance of the user to the notifications pushed to the second computer system.
